(19) United States
(12) Patent Application Publication
(10) Pub. No.: US 2013/0197159 A1
(43) Pub. Date: Aug. 1, 2013

(54) POLYURETHANE ELASTOMER COATINGS

(71) Applicant: Mark T. Anater, Marietta, GA (US)

(72) Inventor: Mark T. Anater, Marietta, GA (US)

(73) Assignee: DOW GLOBAL TECHNOLOGIES LLC, Midland, MI (US)

(21) Appl. No.: 13/876,128

(22) PCT Filed: Oct. 11, 2011
(86) PCT No.: PCT/US11/55674

§ 371 Date: Mar. 26, 2013

Related U.S. Application Data
(60) Provisional application No. 61/391,808, filed on Oct. 11, 2010.

(51) Int. Cl. C09D 175/04

(52) U.S. Cl. CPC C09D 175/04
USPC 524/720; 524/779; 524/786; 524/788; 524/791

(57) ABSTRACT

Embodiments of the invention provide for coatings which include the reaction product of a reaction system, where the reaction system encompasses at least one prepolymer having isocyanate functional groups, where the prepolymer includes the reaction product of at least one isocyanate and at least one polyol having an hydroxyl functionality of between about 2 and about 6. a sodium silicate solution, at least one isocyanate reactive component having at least one of a hydroxyl and an amine functionality of between about 2 and about 4, at least one intumescent filler, at least one filler, and optionally a suspension agent.

### FIELD OF THE INVENTION

Embodiments of the invention relate to polyurethane coatings, more specifically to polyurethane elastomeric coatings that have improved flame resistance.

### BACKGROUND OF THE INVENTION

Polyurethane elastomeric coatings are well-established in industrial applications where a tough, durable protection is required. Examples include roof membranes, waterproofing for building foundations, bridge decking, water and sewage pipes, truck bed liners and secondary containment. Some applications have emerged which also require flame resistance due to building codes or legal liability issues. These include architectural, mining, shipping and transportation. Polyurethane chemistry is not inherently resistant to flame, and thus requires additives to improve this characteristic. Historically the approaches has included halogenated materials, phosphorus containing compounds (phosphates, phosphonates), inorganic fillers, char promoters, intumescent additives and hybrid chemistries using other functional groups such as isocyanurate and oxazolidone. However, the efficiency of these approaches is limited in coatings. Therefore, there is a need for polyurethane elastomeric coatings that have improved flame resistance.

### SUMMARY OF THE INVENTION

Embodiments of the present invention provide for coatings which include the reaction product of a reaction system, where the reaction system encompasses: at least one prepolymer having isocyanate functional groups, where the prepolymer includes the reaction product of at least one isocyanate and at least one polyol having an hydroxyl functionality of between about 2 and about 6. a sodium silicate solution, at least one isocyanate reactive component having at least one of a hydroxyl and an amine functionality of between about 2 and about 4, at least one intumescent filler, at least one filler, and optionally a suspension agent.

Embodiments of the invention also provide for methods of producing coatings, the methods encompass reacting a reaction system where the reacting system includes at least one prepolymer having isocyanate functional groups, wherein the prepolymer includes the reaction product of at least one isocyanate and at least one polyol having an hydroxyl functionality of between about 2 and about 6, a sodium silicate solution, at least one isocyanate reactive component having at least one of a hydroxyl and an amine functionality of between about 2 and about 4, at least one intumescent filler, at least one filler, and optionally a suspension agent.

### BRIEF DESCRIPTION OF THE FIGURES

FIG. 1 is a graph depicting the heat release rate of a comparative example and an example according to an embodiment of the invention.

FIG. 2 is a graph depicting the total smoke produced from a comparative example and an example according to an embodiment of the invention.

### DESCRIPTION OF EMBODIMENTS OF THE INVENTION

Embodiments of the present invention provide polyurethane elastomeric coatings that have improved flame resistance. The embodiments combine a polyurethane prepolymer (which includes a reaction product of at least one isocyanate and at least one polyol) and a mixture of inorganic fillers, intumescent fillers, chain extenders, catalysts, and aqueous silicic acid sodium salt solutions known commonly as waterglass. When mixed, the components cure and form a finished article which has enhanced resistance to flame. Whereas an ordinary polyurethane article may not self-extinguish after just a few seconds of flame exposure, the embodiments of the invention may self-extinguish after several minutes of exposure. Heat release and smoke release rates are also lower for the embodiments of the invention compared to a conventional polyurethane formula.

The polyurethane prepolymer may be the reaction product of at least one isocyanate and at least one polyol. Suitable isocyanates for use in preparing the prepolymer include a wide variety of organic mono- and polyisocyanates. Suitable monoisocyanates include benzyl isocyanate, toluene isocyanate, phenyl isocyanate and alkyl isocyanates in which the alkyl group contains from 1 to 12 carbon atoms. Suitable polyisocyanates include aromatic, cycloaliphatic and aliphatic isocyanates. Exemplary polyisocyanates include m-phenylene diisocyanate, toluene-2-4-diisocyanate, toluene-2-6-diisocyanate, isophorone diisocyanate, 1,3- and/or 1,4-bis(isocyanatomethyl)cyclohexane (including cis- or trans-isomers of either), hexamethylene-1,6-diisocyanate, tetramethylene-1,4-diisocyanate, cyclohexane-1,4-diisocyanate, hexahydrotoluene diisocyanate, methylene bis(cyclohexaneisocyanate) (H₁₂MDI), naphthylene-1,5-diisocyanate, methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, a polymethylene polyphenylisocyanate (PMDI), toluene-2,4,6-triisocyanate and 4,4′-dimethyldiphenylmethane-2,2′,5,5′-tetraisocyanate. In some embodiments, the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-methylene diphenyl isocyanate, diphenylmethane-2,4′-diisocyanate and mixtures thereof are generically referred to as MDI, and all may be used. Toluene-2,4-diisocyanate, toluene-2,6-diisocyanate and mixtures thereof are generically referred to as TDI, and all may be used. In one embodiment, a 50 percent 4,4′ MDI, 50 percent 2,4′ MDI, such as ISONATE 50 OP available from The Dow Chemical Company, is used in combination with a polymeric MDI, such as PAPI 27 available from The Dow Chemical Company.

Derivatives of any of the foregoing isocyanate groups that contain biuret, urea, carbodiimide, allophonate and/or isocyanurate groups may also be used. These derivatives often have increased isocyanate functionalities and are desirably used when a more highly crosslinked product is desired.

The at least one isocyanate may be reacted with at least one polyol to form a prepolymer. The at least one polyol may include at least a first polyol. The first polyol may be a halogenated polyol. In general, the halogenated polyol contributes to flame retardancy by inhibiting the ignition of combustible organic materials. It may also hinder the spread of fire, that is, the time to flashover, thereby providing valuable extra time in the early stages of a fire, during which escape may be possible.

The halogenated polyol may be any suitable halogenated polyol as is known in the art. For example, the halogenated polyol may comprise a polyester polyol, a polyether polyol, or combinations thereof. As another example, the halogenated polyol may comprise an aliphatic polyol, a cycloaliphatic polyol, an aromatic polyol, a heterocyclic polyol, or combination thereof. In one embodiment, the halogenated polyol may be based on dimethyl terephthalate (DMT). In another embodiment, the halogenated polyol comprises an aromatic polyester polyol. One example of a suitable halogenated polyol is an aromatic polyester polyol, commercially available from Oxid, Incorporated under the trade name TEROL 925.

Typically, the halogenated polyol may have a nominal functionality between about 2 and about 6. The halogenated polyol may have an OH value of from about 100 to about 800. It is to be appreciated that the term “halogenated” means comprising one or more of a substituent comprising a halogen atom. When the halogenated polyol includes one or more of the substituents, the substituents may all be the same or may be different from one another. The substituent may be any halogen atom, such as a fluorine atom, a chlorine atom, a bromine atom, an iodine atom, or an astatine atom. Typically, the halogenated polyol comprises one or more substituents selected from the group of a chlorine atom, a bromine atom, and combinations thereof. Without being bound or limited by any particular theory, it is believed that increasing the number of the substituents of the halogenated polyol allows the article to have excellent flammability resistance and test results.

In certain embodiments the halogenated polyol is a brominated polyol. The brominated polyol may be any suitable brominated polyol as is known in the art. For example, the brominated polyol may fall into the class of polyester polyols, a polyether polyols, and combinations thereof. As another example, the brominated polyol may be an aliphatic polyol, a cycloaliphatic polyol, an aromatic polyol, a heterocyclic polyol, and combinations thereof. In one embodiment, the brominated polyol is selected from the group of brominated diols, brominated triols, and combinations thereof. It is to be appreciated that the term “brominated” means comprising one or more bromine atoms. The brominated polyol may comprise other halogen atoms in addition to bromine atoms. In one embodiment, the brominated polyol is tetrabrominated, i.e., comprises four bromine atoms. However, it is to be appreciated that the brominated polyol may comprise more or less than four bromine atoms. One specific example of a suitable brominated polyol is a tetrabromophalate diol, commercially available from Chemtura Corporation under the trade name PHT4-DIOL. Another specific example of a suitable brominated polyol is FIREMASTER 520, which is also commercially available from Chemtura Corporation.

Typically, the halogenated polyol is included in an amount of from 2 to 45 weight % of the total weight of all the components included to make the prepolymer. All individual values and subranges between about 2 and about 45 weight % are included herein and disclosed herein; for example, the amount can be from a lower limit of about 2, 4, 5, 10, 15, 20, 25, 30, or 35 to an upper limit of about 10, 15, 20, 25, 30, 35, 40, or 45 weight %.

The at least one polyol may also include at least a second polyol. The second polyol may be a supplemental polyol different from the halogenated polyol. The second polyol may be any suitable polyol as is known in the art. For example, the second polyol may comprise a polyester polyol, a polyether polyol, or combinations thereof. As another example, the second polyol may comprise an aliphatic polyol, a cycloaliphatic polyol, an aromatic polyol, a heterocyclic polyol, or combinations thereof. As yet another example, the second polyol may comprise a sucrose polyol, a sucrose/glycerine polyol, a trimethylolpropane polyol, or combinations thereof.

The second polyol may have a nominal functionality of from 2-8. Typically, the second polyol has a nominal functionality of from 2 to 4. Typically, the second polyol has an OH value of from 25 to 800, such as from 25 to 600, or from 50 to 570 mg KOH/g. Additionally, the second polyol may have a number average molecular weight of between about 150 and about 5000 or between about 200 and about 2000.

In one embodiment, the second polyol is a propylene glycol initiated propylene oxide diol having a number average molecular weight of 2000.

Typically, the second polyol is included in an amount of from 0 to 70 weight % of the total weight of all the components included to make the prepolymer. All individual values and subranges between about 2 and about 45 weight % are included herein and disclosed herein; for example, the amount can be from a lower limit of about 0, 5, 10, 15, 20, 25, 30, 35, 40, or 45 to an upper limit of about 15, 20, 25, 30, 35, 40, 45, 50, 55, 60, 65, or 70 weight %.

Reaction of the at least one polyol with the isocyanate can be catalyzed using at least one catalyst within the skill in the art for such reactions. Examples of urethane catalysts include tertiary amines such as triethylamine, 1,4-diazabicyclo[2.2.2.]octane (DABCO), N-methylmorpholine, N-ethylmorpholine, N,N,N′,N′-tetramethylhexamethylenediamine, 1,2-dimethylimidazol; and tin compounds such as tin(II)acetate, tin(II)octanoate, tin(II)laurate, dibutyltin dilaurate, dibutyltin dimaleate, dioctyltin diacetate and dibutyltin dichloride. In one embodiment the catalyst is benzoyl chloride. The catalysts are optionally used alone or as mixtures thereof. The reaction may be heated to temperatures between 20° C. and 100° C., and may take 2-6 hours to complete.

The proportions of the isocyanate and the at least first and second polyol composition are chosen to provide an isocyanate terminated prepolymer product. This can be accomplished by using excess stoichiometric amount of polyisocyanate, that is, more than one isocyanate group per active hydrogen group the polyol compositions. The ratio of isocyanate groups to active hydrogen, preferably hydroxyl and amine groups, on polyol composition is preferably at least about 1.0, 1.2. 1.4, 1.5, 1.7, or 1.8, and independently preferably at most about 10, preferably at most about 6, preferably at most about 3. Higher (that is stoichiometric amounts or excess) isocyanate levels are optionally used.

The prepolymer is reacted in a reaction system that includes the prepolymer and at least one isocyanate reactive component, at least one sodium silicate solution, at least one filler, at least one intumescent filler, and optionally, at least one suspension agent. Other components such as surfactants, catalysts, preservatives, and antioxidants may be included as well.

The at least one isocyanate reactive component is a material having at least two isocyanate-reactive groups per molecule and an equivalent weight per isocyanate-reactive group of less than 400, such as less than 300, or in the range of 31-125 daltons. Representative of suitable isocyanate reactive components include polyhydric alcohols, aliphatic or aromatic diamines including polyoxyalkylenediamines, and mixtures thereof. The isocyanate reactive groups are preferably hydroxyl, primary aliphatic amine or secondary aliphatic amine groups. The isocyanate reactive components may be aromatic, aliphatic or cycloaliphatic, and are exemplified by triols, tetraols, diamines, triamines, aminoalcohols, and the like. Representative chain extenders include ethylene glycol, diethylene glycol, 1,3-propane diol, 1,3- or 1,4-butanediol, dipropylene glycol, 1,2- and 2,3-butylene glycol, 1,6-hexanediol, neopentylglycol, tripropylene glycol, 1,2-ethylhexyldiol, ethylene diamine, 1,4-butylenediamine, 1,6-hexamethylenediamine, 1,5-pentanediol, 1,6-hexanediol, 1,3-cyclohexandiol, 1,4-cyclohexanediol; 1,3-cyclohexane dimethanol, 1,4-cyclohexane dimethanol, N-methylethanolamine, N-methyliso-propylamine, 4-aminocyclohexanol, 1,2-diaminotheane, 1,3-diaminopropane, hexylmethylene diamine, methylene bis(aminocyclohexane), isophorone diamine, 1,3- or 1,4-bis(aminomethyl) cyclohexane, diethylenetriamine, 3,5-diethyltoluene-2,4-diamine and 3,5-diethyltoluene-2,6-diamine, and mixtures or blends thereof. Suitable primary diamines include for example dimethylthiotoluenediamine (DMTDA) such as Ethacure 300 from Albermarle Corporation, diethyltoluenediamine (DETDA) such as Ethacure 100 Ethacure from Albermarle (a mixture of 3,5-diethyltoluene-2,4-diamine and 3,5-diethyltoluene-2,6-diamine), isophorone diamine (IPDA), and dimethylthiotoluenediamine (DMTDA).

Between about 1 and about 35 parts per weight of the reaction system excluding the prepolymer may include at least one isocyanate reactive component. All individual values and subranges between about 1 and about 35 parts per weight are included herein and disclosed herein; for example, the amount can be from a lower limit of about 1, 2, 5, 10, 15, 20, or 25 parts by weight to an upper limit of about 7, 10, 15, 20, 25, 30, or 35 parts by weight.

The at least one sodium silicate solution, or waterglass as it is also known, is a versatile, inorganic chemical made by combining various ratios of silica and soda ash (sodium carbonate) at high temperature and dissolving the resulting sodium silicate in a solvent, such as for example water. Weight ratios of SiO₂/Na₂O may be between about 1.4/1 to about 3.5/1, or between about 1.6/1 to about 3.22/1. The solutions may have sodium silicate concentrations of between about 5% and about 75% by weight. All individual values and subranges between about 5 and about 5% by weight are included herein and disclosed herein; for example, the concentration can be from a lower limit of about 5, 10, 15, 20, 25, 30, or 35% by weight to an upper limit of about 20, 25, 30, 35, 40, 45, 50, 55, 60, 65, 70, or 75% by weight. Suitable sodium silicate solutions are available from, for example, PQ Corporation under the trade designations A1647, A2445, A2447, A2645, BJ120, BW50, D, E, K, M, N, NClear, N38, O, OW, RU, SS, SS22, SS75, STAR, STIXSORR, and V. Between about 10 and about 70 parts per weight of the reaction system excluding the prepolymer may include the sodium silicate solution. All individual values and subranges between about 10 and about 70 parts per weight are included herein and disclosed herein; for example, the amount can be from a lower limit of about 10, 15, 20, 25, 30, or 35 parts by weight to an upper limit of about 20, 25, 30, 35, 40, 45, 50, 55, 60, 65, or 70 parts by weight.

The at least one filler may include barium sulfate (BaSO₄), aluminum oxide (Al₂O₃), aluminum hydroxide (Al(OH)₃), magnesium hydroxide (Mg(OH)₂) calcium carbonate (CaCO₃) mica, and talc. Between about 5 and about 50 parts per weight of the reaction system excluding the prepolymer may include the filler. All individual values and subranges between about 5 and about 50 parts per weight are included herein and disclosed herein; for example, the amount can be from a lower limit of about 5, 10, 15, 20, 25, 30, 35 parts by weight to an upper limit of about 20, 25, 30, 35, 40, 45, or 50 parts by weight.

The at least one intumescent filler may include expandable graphite or melamine. Suitable expandable graphite is available from, for example, Nyacol Inc. under the trade designation NYAGRAPH. Between about 2 and about 45 parts per weight of the reaction system excluding the prepolymer may include the intumescent filler. All individual values and subranges between about 2 and about 50 parts per weight are included herein and disclosed herein; for example, the amount can be from a lower limit of about 2, 5, 10, 15, 20, 25, 30, or 35 parts by weight to an upper limit of about 20, 25, 30, 35, 40, or 45 parts by weight.

The at least one optional suspension agent may include a thixotrope such as calcinated clay. Between about 2 and about 35 parts per weight of the reaction system excluding the prepolymer may include the suspension agent. All individual values and subranges between about 2 and about 35 parts per weight are included herein and disclosed herein; for example, the amount can be from a lower limit of about 2, 5, 10, 15, 20, 25, or 30 parts by weight to an upper limit of about 20, 25, 30, or 35 parts by weight.

The reaction system is then used to form a polyurethane product, such as for example a spray elastomer or coating. In one embodiment, a coating may be made by using plural component equipment which combines two components, an (a) component and a (b) component. The (a) component generally may include the isocyanate prepolymer and any other isocyanate functional materials, while the (b) component generally includes the rest of the components of the reaction system. Other additives may also be included in the resin blend component as noted previously.

The (a) component and (b) component are placed in two separate feeder tanks with optional heating capability. The materials are transferred via pumps to a metering system set to feed the materials at a predetermined volume ratio. The predetermined volume ratio may be between about 5:1 and about 1:5. In an embodiment, it is 1:1. At the application point the components are mixed via static or dynamic action and applied onto a substrate at 200-400 psi with optional air assist.

Embodiments of the invention include polyurethane spray elastomer systems where plural component, high pressure, high temperature spray equipment is used. The (a) component and the (b) component of the polyurethane spray elastomer systems may be combined or mixed under high pressure. In an embodiment, they are impingement mixed directly in the high-pressure spray equipment. This equipment includes, for example: an Isotherm PSM 700 plural component metering system and SP 300H gun at 100-240° F., 100-200 bar and a #3 or #4 mixing module. The two components are mixed in a mixing chamber under high pressure inside the spray gun and both reactants are undergoing a turbulent, laminar mix process which yields the reaction mixture which is then applied to the desired substrate via the spray gun. The coating/lining system is formed when the reacting mixture hits the substrate and wets it out to form a coherent coating or lining. The use of plural component spray equipment, however, is not critical to the present invention and is included only as one example of a suitable method for mixing the spray elastomers of the embodiments of the present invention.

### EXAMPLES

The following examples are provided to illustrate the embodiments of the invention, but are not intended to limit the scope thereof. All parts and percentages are by weight unless otherwise indicated.

The following materials were used:

| | |
|---|---|
| M sodium | 44.6% solution of sodium silicate (silicic acid |
| silicate solution | sodium salt) in water, 2.58 ratio of silica to sodium |
| | hydroxide (2.58SiO2•Na2O) from PQ Corporation. |
| ETHACURE | A primary diamine curing agent consisting of a |
| 100 | mixture of mostly 3,5-diethyltoluene-2,4-diamine |
| | and 3,5-diethyltoluene-2,6-diamine. Available |
| | from Albemarle Corporation. |
| Ethylene | 1,2-ethanediol available from Ashland |
| glycol | |
| MARTINAL | An alumina trihydride, Al2O3•3H2O from |
| OL 104 LEO | Albemarle Corporation. |
| GLOMAX LL | A dehydroxylated aluminum silicate from Imerys. |
| NYAGRAPH | Expandable graphite flakes from Nyacol Inc. |
| 200 | |
| DABCO | A tin catalyst (dibutyltindilaurate) available from |
| T-12 | Air Products and Chemicals, Inc. |
| DABCO | Bis(2.2-morpholinoethyl)ether available from Air |
| DMDEE | Products and Chemicals, Inc. |
| ISONATE* | A 50 percent 4,4′-methylene diphenyl isocyanate, |
| 50 OP | 50 percent 2,4′-methylene diphenyl isocyanate |
| | mixture having a functionality of 2.0 and an |
| | equivalent weight of 125 g/equivalent available |
| | from The Dow Chemical Company. |
| PAPI* 27 | A polymeric MDI (polymethylene polyphenyl- |
| | isocyanate) available from The Dow Chemical |
| | Company having a functionality of approximately |
| | 2.7, an isocyanate equivalent weight of approxi- |
| | mately 134 and an NCO content by weight of |
| | about 31.4%. |
| VORANOL* | A propylene glycol initiated propylene oxide |
| 220-056N | diol having a number average molecular weight of |
| | 2000, available from The Dow Chemical Company. |
| PHT-4 DIOL | 1,2-Benzenedicarboxylic acid, 3,4,5,6-tetrabromo-, |
| | mixed esters with diethylene glycol and propylene |
| | glycol available from Chemtura Corporation. |
| Benzoyl | Available from Sigma-Aldrich Co. |
| chloride | |
| HYPERCOAT* | A polyester polyurethane system with phosphate, |
| SMP-90A-FR | alumina trihydrate, and melamine, available from |
| | The Dow Chemical Company. |

*HYPERCOAT, ISONATE, PAPI and VORANOL are trademarks of The Dow Chemical Company.

### Prepolymer Component

ISONATE OP 50 (35.18 parts) is added to a reactor vessel, and heated to about 160° F. Benzoyl chloride (0.01 parts) is then added, followed by VORANOL 220-056N (46.63 parts) at a controlled rate over about 0.5-1 hour with agitation until all is added. The reaction mixture is digested for about 3 hours and checked for target isocyanate concentration (according to ASTM D5155) of 12.5 weight percent of the mixture,. PHT-4 DIOL (9.09 parts) is then added and digested for about 1-2 hours. The reaction mixture is checked for a target isocyanate concentration of 9.7% weight percent of the mixture. PAPI 27 (9.09 parts) is added and the reaction mixture is checked for a target isocyanate concentration of 11% weight percent of the mixture.

### Polyol Component:

M sodium silicate Solution (47.90 parts), ETHACURE 100 (5 parts), ethylene glycol (5 parts), DABCO T12 (0.05 parts) and DABCO DMDEE (0.05 parts) are added to a mixing vessel at ambient temperature, and mixed to combine. MARTINAL OL 104 LEO (25.00 parts) and GLOMAX LL (2.00 parts) are added and mixed until the blend is homogeneous and all particles are fully incorporated. NYAGRAPH 200 (15 parts) is added and mixed carefully under low shear to avoid damaging the flakes until all particles are fully incorporated and dispersed evenly.

### Application (Example E1)

The Prepolymer Component and the Polyol Component are placed in two separate feeder tanks with an optional heating capability set to heat at 90-105° F.. The materials are transferred via pumps to a metering system set to feed the materials at a 1:1 volume ratio. At the application point the components are mixed via static action and applied onto a substrate at 200-400 psi with optional air assist to form a film having a target thickness of 2 mm

### Application (Comparative Example CE1)

The prepolymer component and the polyol component of the HYPERCOAT* SMP-90A-FR system are placed in two separate feeder tanks with the optional heating capability set to heat at 140° F.. The materials are transferred via pumps to a metering system set to feed the materials at a 1:1 volume ratio. At the application point the components are mixed via static action and applied onto a substrate at 2000 psi with optional air assist to form a film having a target thickness of 2 mm.

### Heat Release Rate and Total Smoke Produced

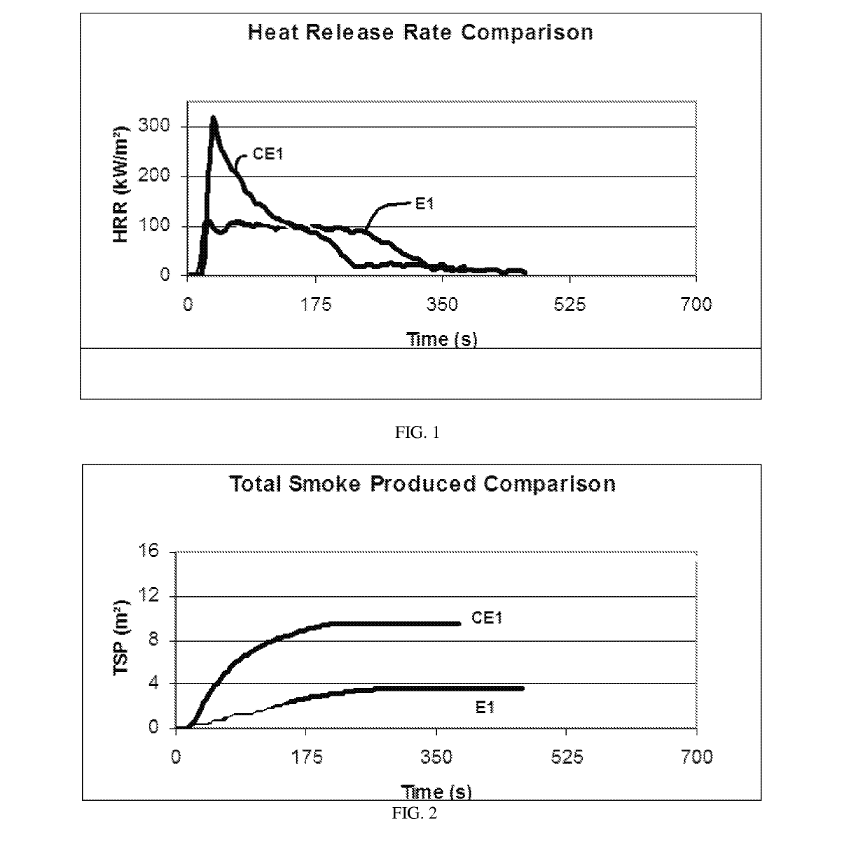

The heat release rate and the total smoke produced are measured on samples applied to plastic sheet substrates which are peeled off from the finished film. The heat release rate and the total smoke produced are measured according to ASTM E1354-10a Standard Test Method for Heat and Visible Smoke Release Rates for Materials and Products Using an Oxygen Consumption calorimeter. FIG. 1 is a graph depicting the heat release rate of E1 and CE1, and FIG. 2 is a graph depicting the total smoke produced of El and CE1. It can be seen that E1 has a generally lower heat release rate and produces less total smoke than CE1.

### Steiner Tunnel Test

Steiner Tunnel test is performed according to ASTM E84-09 (Standard Test Method for Surface Burning Characteristics of Building Materials) on samples applied to a National Gypsum PERMABASE cement board substrate. Results are given in Table 1.

TABLE 1

| | Flame Spread | Smoke Developed |
|---|---|---|
| Test Specimen | Index | Index |
| Fiber-Reinforced Cement | 100 | 0 |
| Board, Grade II | | |
| Red Oak Flooring | 100 | 100 |
| E1 | 30 | 450 |

While the foregoing is directed to embodiments of the present invention, other and further embodiments of the invention may be devised without departing from the basic scope thereof, and the scope thereof is determined by the claims that follow.

1. A coating comprising the reaction product of a reaction system, the reaction system comprising:
at least one prepolymer having isocyanate functional groups, wherein the prepolymer comprises the reaction product of at least one isocyanate and at least one polyol having an hydroxyl functionality of between about 2 and about 6;
a sodium silicate solution
at least one isocyanate reactive component having at least one of a hydroxyl and an amine functionality of between about 2 and about 4;
at least one intumescent filler;
at least one filler; and
optionally a suspension agent.

2. The coating of claim 1, wherein the prepolymer comprises the reaction product of at least one isocyanate, at least one halogenated isocyanate reactive component having an hydroxyl functionality of between about 2 and about 6, and at least one polyether polyol having hydroxyl functionality of between about 2 and about 4, a number average molecular weight of between about 150 and about 5000 and an OH value between about 25 and about 800.

3. The coating of claim 2, wherein the at least one halogenated isocyanate reactive component comprises a brominated diol having an OH value between about 100 and about about 800.

4. (canceled)

5. The coating of claim 1, wherein the sodium silicate solution has a weight ratio of SiO₂/Na₂O of between about 1.4/1 and about 3.5/1.

6. The coating of claim 1, wherein the at least one isocyanate reactive component has an equivalent weight per isocyanate-reactive group of between about 31 and about 125 daltons.

7. The coating of claim 1, wherein the at least one filler may comprises at least one of barium sulfate (BaSO₄), aluminum oxide (Al₂O₃), aluminum hydroxide (Al(OH)₃), magnesium hydroxide (Mg(OH)₂) calcium carbonate (CaCO₃), mica, and talc.

8. The coating of claim 1, wherein the at least one intumescent filler is at least one of expandable graphite and melamine.

9. The coating of claim 1, wherein the at least one optional suspension agent comprises calcinated clay.

10. The coating of claim 2, wherein the at least one polyether polyol is a propylene glycol initiated propylene oxide diol.

11. The coating of claim 10, wherein the at least one isocyanate comprises at least one polymeric polymethylene polyphenylisocyanate and at least one mixture of 4,4′-methylene diphenyl isocyanate and 2,4′-methylene diphenyl isocyanate.

12. The coating of claim 11, wherein the prepolymer comprises the reaction product of the reaction of at least the at least one mixture of 4,4′-methylene diphenyl isocyanate and 2,4′-methylene diphenyl isocyanate with the at least one polyether polyol followed by a reaction with the at least one halogenated isocyanate reactive component, and then with the at least one polymeric polymethylene polyphenylisocyanate.

13. A method of producing a coating, the method comprising:
reacting a reaction system, the reacting system comprising:
at least one prepolymer having isocyanate functional groups, wherein the prepolymer comprises the reaction product of at least one isocyanate and at least one polyol having an hydroxyl functionality of between about 2 and about 6;
a sodium silicate solution
at least one isocyanate reactive component having at least one of a hydroxyl and an amine functionality of between about 2 and about 4;
at least one intumescent filler;
at least one filler; and
optionally a suspension agent.

14. The method of claim 13, wherein the at least one isocyanate comprises at least one polymeric polymethylene polyphenylisocyanate and at least one mixture of 4,4′-methylene diphenyl isocyanate and 2,4′-methylene diphenyl isocyanate.

15. The method of claim 13, wherein the preplymer is made by at least:
a) reacting the at least one mixture of 4,4′-methylene diphenyl isocyanate and 2,4′-methylene diphenyl isocyanate with the at least one polyether polyol
b) reacting a product of step a) with at least one halogenated isocyanate reactive component; and
c) reacting a product of step b) with the at least one polymeric polymethylene polyphenylisocyanate.

16. The method of claim 15, wherein the at least one halogenated isocyanate reactive component comprises a tetrabromophalate diol.

17. The method of claim 16, wherein the sodium silicate solution has a weight ratio of SiO₂/Na₂O of between about 1.4/1 and about 3.5/1.

18. The method of claim 13, wherein the at least one isocyanate reactive component has an equivalent weight per isocyanate-reactive group of between about 31 and about 125 daltons.

19. The method of claim 13, wherein the at least one intumescent filler may comprises at least one of barium sulfate (BaSO₄), aluminum oxide (Al₂O₃), aluminum hydroxide (Al(OH)₃), magnesium hydroxide (Mg(OH)₂) calcium carbonate (CaCO₃), mica, and talc.

20. The method of claim 13, wherein the at least one intumescent filler is at least one of expandable graphite and melamine.

21. (canceled)

22. (canceled)

23. The method of claim 15, wherein the at least one halogenated isocyanate reactive component comprises a brominated diol having an OH value between about 100 and 800.
